(19) United States
(12) Patent Application Publication
(10) Pub. No.: US 2025/0124349 A1
(43) Pub. Date: Apr. 17, 2025

(54) COMPUTER-READABLE RECORDING MEDIUM STORING ARITHMETIC PROGRAM, ARITHMETIC METHOD, AND INFORMATION PROCESSING DEVICE

(71) Applicant: Fujitsu Limited, Kawasaki-shi (JP)

(72) Inventors: Akito MARUO, Atsugi (JP); Hideyuki JIPPO, Atsugi (JP); Takeshi SOEDA, Kawasaki (JP)

(73) Assignee: Fujitsu Limited, Kawasaki-shi (JP)

(21) Appl. No.: 18/825,006

(22) Filed: Sep. 5, 2024

(30) Foreign Application Priority Data
Oct. 16, 2023 (JP) 2023-178238

(51) Int. Cl. G06N 20/00; G06N 7/01

(52) U.S. Cl. CPC G06N 20/00; G06N 7/01

(57) ABSTRACT

A non-transitory computer-readable recording medium storing an arithmetic program for causing a computer to repeatedly execute processing including: generating a plurality of training data sets from a training data group; creating a plurality of Ising models by creating the Ising models for each of the plurality of training data sets; creating a combined Ising model by combining the plurality of Ising models according to an average and a deviation of coefficients of the plurality of Ising models; searching for a recommended point for the combined Ising model; and adding the recommended point and an evaluation value of the recommended point to the training data group.

### CROSS-REFERENCE TO RELATED APPLICATION

This application is based upon and claims the benefit of priority of the prior Japanese Patent Application No. 2023-178238, filed on Oct. 16, 2023, the entire contents of which are incorporated herein by reference.

### FIELD

The embodiments discussed herein are related to an non-transitory computer-readable recording medium storing an arithmetic program, an arithmetic method, and an information processing device.

### BACKGROUND

A technique for performing optimization using a model is disclosed.

International Publication Pamphlet No. WO 2021-059604, Japanese National Publication of International Patent Application No. 2021-504836, and Japanese Laid-open Patent Publication No. 2021-149160 are disclosed as related art.

### SUMMARY

According to an aspect of the embodiments, there is provided a non-transitory computer-readable recording medium storing an arithmetic program for causing a computer to repeatedly execute processing including: generating a plurality of training data sets from a training data group; creating a plurality of Ising models by creating the Ising models for each of the plurality of training data sets; creating a combined Ising model by combining the plurality of Ising models according to an average and a deviation of coefficients of the plurality of Ising models; searching for a recommended point for the combined Ising model; and adding the recommended point and an evaluation value of the recommended point to the training data group.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a search for a solution in a QUBO format;

FIG. 2A is a diagram illustrating training data for a structure and a characteristic, and FIG. 2B is an example of output of a factorization machine with digital annealer (FMDA);

FIG. 3 is a flowchart representing an execution procedure in a sampling technique using a model in the QUBO format;

FIG. 4A is a block diagram illustrating an overall configuration of an information processing device, and FIG. 4B is a block diagram illustrating a hardware configuration of the information processing device;

FIG. 5 is a flowchart representing an exemplary operation of the information processing device;

FIG. 6 is a flowchart representing details of step S13;

FIG. 7 is a diagram in which an embodiment is summarized in order;

FIG. 8A is a diagram illustrating an optimization problem for a magnetic shield, FIG. 8B is a diagram illustrating locations by a Gaussian basis function, and FIG. 8C is a diagram illustrating magnetic flux lines generated from a coil;

FIG. 9 is a diagram illustrating positive locations and negative locations;

FIG. 10 is a diagram illustrating a shape function;

FIG. 11 is a diagram indicating a simulation result; and

FIG. 12 is a diagram indicating a simulation result.

### DESCRIPTION OF EMBODIMENTS

For example, a technique for achieving optimization by sampling using an Ising model in a QUBO format is an approach for sequentially sampling recommended points on the model, and thus, a sampling region may be likely to be limited. For this reason, the number of times of sampling may be likely to increase, as a result.

In one aspect, an object of the present case is to provide an arithmetic program, an arithmetic method, and an information processing device capable of reducing the number of times of sampling.

As a technique for searching a large number of combinations, orders, and the like for a good solution having a high evaluation value, a binary variable sampling technique is used. As the binary variable sampling technique, a sampling technique for randomly performing sampling, a sampling technique using an Ising model in a QUBO format, or the like is exemplified.

The sampling technique for randomly performing sampling allows sampling to be easily performed, but has a disadvantage that sampling efficiency is poor, and the number of times of sampling will increase in order to obtain a good solution with high accuracy.

For example, as the sampling technique using a model in the QUBO format, a factorization machine with quantum annealing (FMQA) or the like is exemplified. FMQA is an approach in which quantum annealing (QA) and a factorization machine (FM; machine learning approach) are combined. FMQA is an approach for performing interactive sampling in which an FM model in the QUBO format is created from training data, a good solution is obtained by QA, an evaluation value of the good solution is analyzed by a solver, and a result is added to the training data. Besides, a factorization machine with digital annealer (FMDA) technique is exemplified as a sampling technique using a model in the QUBO format. FMDA is obtained by replacing the QA portion of FMQA with a digital annealer (DA).

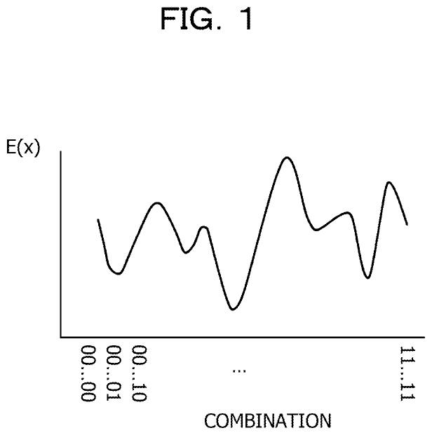

Here, the QUBO format stands for quadratic unconstrained binary optimization that is a format in which binary optimization is allowed without a secondary constraint. The QUBO format can be expressed, for example, as in the following formula. Note that xᵢ=0 or 1 (i=1, . . . , N) holds. A coupling coefficient of xᵢ and xⱼ is denoted by Wᵢⱼ. A bias coefficient of xᵢ is denoted by bᵢ. The first term on the right side is a quadratic term and represents an interaction. The second term on the right side is a linear term and represents a bias action. The third term on the right side is a constant term. In the QUBO format, as illustrated in FIG. 1, a good solution x for minimizing E(x) representing energy is searched for, in accordance with the following formula.

### [Mathematical Formula 1]

$$E ( x ) = - {\sum }_{i , j} {W}_{ij} {x}_{i} {x}_{j} - {\sum }_{i} {b}_{i} {x}_{i} + const .$$

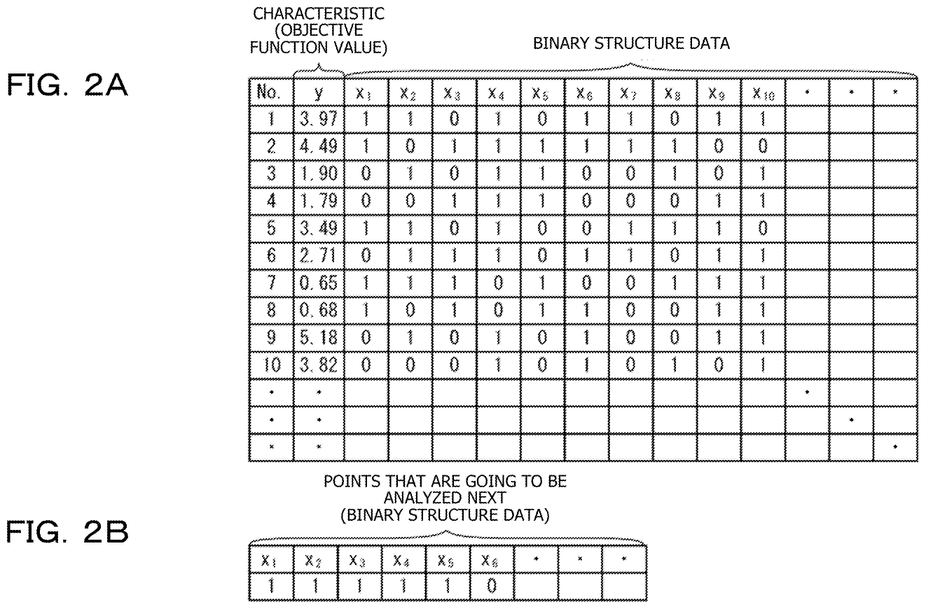

Here, an outline of the FMDA will be described as an example of a sampling technique using an Ising model in the QUBO format. FIG. 2A is a diagram illustrating training data for a structure and a characteristic. The characteristics represented by the values of y are the objective function values. Data represented by an n-dimensional vector of x is binary structure data. The data in FIG. 2A is input to the FMDA. FIG. 2B is an example of output (recommended points) of the FMDA. The recommended points are evaluated by being analyzed by a solver.

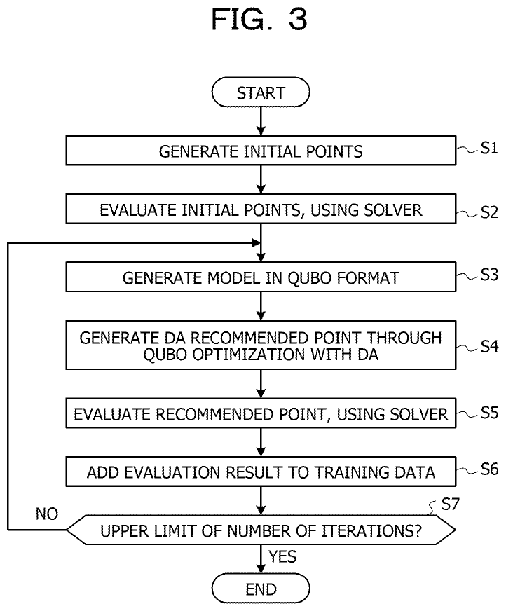

FIG. 3 is a flowchart representing an execution procedure in a sampling technique using an Ising model in the QUBO format. As illustrated in FIG. 3, first, a training data group is generated by randomly generating training data (initial points) (step S1). The number of pieces of training data to be generated is determined by user setting.

Next, an evaluation value of the initial points is calculated using the solver (step S2). The evaluation value is an index for assessing whether or not the initial point or a recommended point to be described later is good. Through the above steps, an initial training data group in which the initial points and the evaluation values are collected as sets is generated.

Next, an FM is generated with the training data group, whereby an Ising model in the QUBO format is created (step S3). Since the FM is in the QUBO format, generating an FM is equivalent to generating an Ising model in the QUBO format. Any other machine learning model can also be used as long as the machine learning model can generate an Ising model in the QUBO format.

Next, the created Ising model in the QUBO format is optimized using a DA, and a good solution (DA recommended point) giving the best evaluation value is generated (step S4).

Next, an evaluation value of the DA recommended point is calculated using the solver (step S5).

Next, an evaluation result (a set of the recommended point and the evaluation value) is added to the training data group as training data (step S6).

Next, it is verified whether or not the number of iterations has reached an upper limit (step S7). In a case where it is verified as “No” in step S7, step S3 and the subsequent steps are executed again. This ensures that steps S3 to S6 are repeated until an end condition is satisfied. In a case where it is verified as “Yes” in step S7, the execution of the flowchart ends. Note that, as the end condition, a condition such as a case where an amount of change in the objective function is less than a threshold value over a certain period of time can be used.

The training data group is updated by the above procedure, allowing an optimal solution to be obtained.

Note that, although the FMDA has been described in FIG. 3, the DA portion of the FMDA may be replaced with QA, and any other approach can be used as long as its Ising machine is capable of solving QUBO. In addition, apart from using an Ising machine dedicated to solving QUBO, the Ising model may be solved using software.

The sampling technique using a model in the QUBO format is an approach for sequentially sampling the recommended points on the Ising model, and thus, a sampling region may be likely to be limited. In addition, in the sampling technique using the Ising model in the QUBO format, sampling performance will vary depending on the training data group for generating the Ising model. In addition, since the FM is a quadratic Ising model, there is a possibility that the problem may not be fully expressed. From the above, the number of times of sampling will increase in order to enhance the search accuracy for an optimal solution.

Thus, in the following embodiment, an example in which the number of times of sampling may be reduced will be described.

### First Embodiment

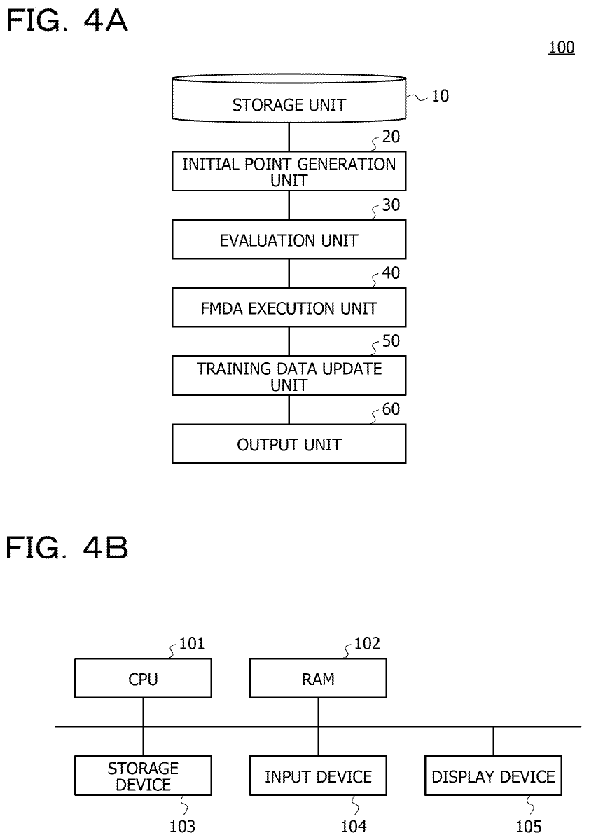

FIG. 4A is a block diagram illustrating an overall configuration of an information processing device 100. As illustrated in FIG. 4A, the information processing device 100 includes a storage unit 10, an initial point generation unit 20, an evaluation unit 30, an FMDA execution unit 40, a training data update unit 50, an output unit 60, and the like.

FIG. 4B is a block diagram illustrating a hardware configuration of the information processing device 100. As illustrated in FIG. 4B, the information processing device 100 includes a central processing unit (CPU) 101, a random access memory (RAM) 102, a storage device 103, an input device 104, a display device 105, and the like.

The central processing unit (CPU) 101 is a central processing device. The CPU 101 includes one or more cores. The random access memory (RAM) 102 is a volatile memory that temporarily stores a program to be executed by the CPU 101, data to be processed by the CPU 101, and the like. The storage device 103 is a nonvolatile storage device. As the storage device 103, for example, a read only memory (ROM), a solid state drive (SSD) such as a flash memory, a hard disk to be driven by a hard disk drive, or the like can be used. The storage device 103 stores an arithmetic program. The input device 104 is an input device such as a keyboard or a mouse. The display device 105 is a display device such as a liquid crystal display (LCD). The storage unit 10, the initial point generation unit 20, the evaluation unit 30, the FMDA execution unit 40, the training data update unit 50, the output unit 60, and the like are implemented by the CPU 101 executing the arithmetic program. Note that hardware such as a dedicated circuit may be used as the storage unit 10, the initial point generation unit 20, the evaluation unit 30, the FMDA execution unit 40, the training data update unit 50, the output unit 60, and the like.

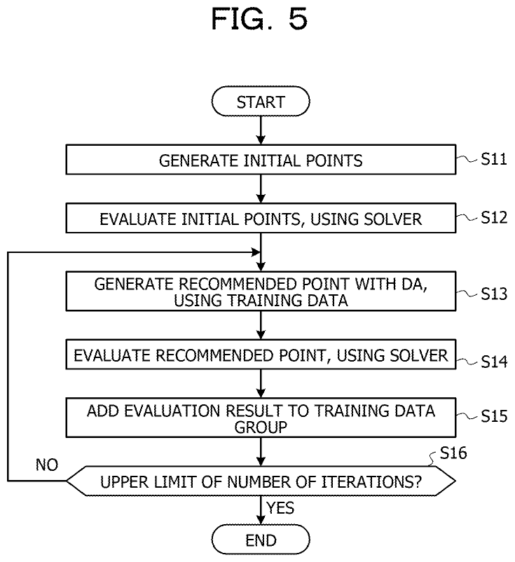

FIG. 5 is a flowchart representing an exemplary operation of the information processing device 100. As illustrated in FIG. 5, the initial point generation unit 20 generates a training data group by randomly generating initial points of the training data (step S11). The number of pieces of training data to be generated is determined by user setting. In addition, the initial points of the training data may be set by the user.

Next, the evaluation unit 30 calculates an evaluation value of each initial point, using the solver (step S12). The initial training data group in which the initial points obtained in step S11 and the evaluation values calculated in step S12 are collected as sets is stored in the storage unit 10.

Next, the FMDA execution unit 40 generates a DA recommended point, using the training data group stored in the storage unit 10 (step S13).

Next, the evaluation unit 30 calculates an evaluation value of the recommended point, using the solver (step S14).

Next, the training data update unit 50 adds an evaluation result (a set of the recommended point and the evaluation value) to the training data group as training data (step S15).

Next, the FMDA execution unit 40 verifies whether or not the number of iterations has reached an upper limit (step S16). The number of executions of step S16 can be treated as the number of iterations. The upper limit number of the number of iterations is preset by the user.

In a case where it is verified as “No” in step S16, step S13 and the subsequent steps are executed again. In a case where it is verified as “Yes” in step S16, the execution of the flowchart ends.

The output unit 60 outputs a result of the process in FIG. 5. For example, the output result is displayed on the display device 105. For example, the output unit 60 may output the contents of the training data group, or may output training data having a higher evaluation value in the training data group, as a good solution.

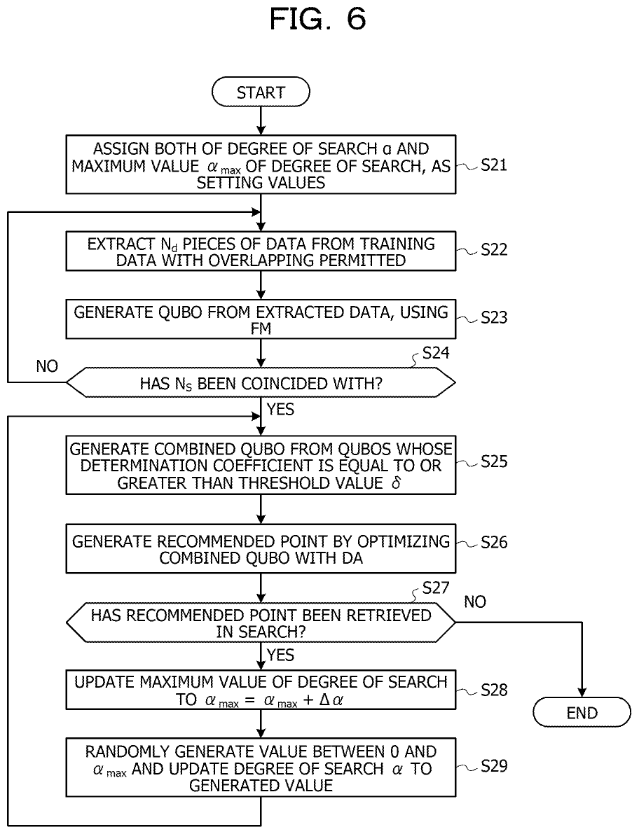

FIG. 6 is a flowchart representing details of step S13. As illustrated in FIG. 6, the FMDA execution unit 40 assigns both of a degree of search α and a maximum value αₘₐₓ of the degree of search, as setting values (step S21). The degree of search α and the maximum value αₘₐₓ of the degree of search are predefined by the user or the like.

Next, the FMDA execution unit 40 extracts N_{d} pieces of training data as a training data set from the training data group stored in the storage unit 10 (step S22). The number of pieces of picked-up data predefined by the user or the like is denoted by N_{d}. The number denoted by N_{d} is smaller than the number of pieces of training data included in the training data group.

Next, the FMDA execution unit 40 generates an FM from the training data set extracted in step S22 and generates an Ising model by converting the generated FM into QUBO (step S23). Since the FM is in the QUBO format, generating an FM is equivalent to generating an Ising model in the QUBO format. Any other machine learning model can also be used as long as the machine learning model can generate an Ising model in the QUBO format.

Next, the FMDA execution unit 40 verifies whether or not the number of times of generation of the Ising model in the QUBO format has coincided with a number N_{S} of generated QUBOs (step S24). In a case where it is verified as “No” in step S24, step S22 and the subsequent steps are executed again.

By repeatedly executing steps S22 to S24, N_{S} Ising models are generated. Note that the training data sets extracted every time step S22 is executed have at least partially different training data. For example, when data No. 1 to No. 10 are extracted at the first time and data No. 15 to No. 24 are extracted at the second time, partially overlapping but different data sets will be included. Alternatively, all the training data included in each training data set may be different for each training data set. For example, when data No. 1 to No. 10 are extracted at the first time and data No. 11 to No. 20 are extracted at the second time, all data will be different from each other.

Note that, in a case where a small number of pieces of training data are included in the training data group, it is preferable to make the training data sets partially overlapping each other when generating each training data set. For example, data No. 1 to No. 5 is assigned as a first training data set, data No. 2 to No. 6 is assigned as a second training data set, data No. 3 to No. 7 is assigned as a third training data set, and so forth. In this case, a plurality of types of training data sets can be generated even if the number of initial points is small.

In a case where it is verified as “Yes” in step S24, the FMDA execution unit 40 generates a combined QUBO from Ising models whose determination coefficient R² is equal to or greater than a threshold value δ, according to an average and a deviation of the coefficients (step S25).

By repeating above step S23 to generate each Ising model, E(x) in the QUBO format described with reference to FIG. 1 is obtained each time. For each E(x), Wᵢⱼ, bᵢ, and const. are all obtained. For each E(x), an average value of Wᵢⱼ is assumed as Wᵢⱼ_ave, an average value of bᵢ is assumed as bᵢ_ave, and an average value of const. is assumed as const._ave. For each E(x), a standard deviation of Wᵢⱼ is assumed as Wᵢⱼ_σ, a standard deviation of bᵢ is assumed as bᵢ_σ, and a standard deviation of const. is assumed as const._σ. As an example, in E(x) in the QUBO format described with reference to FIG. 1, Wᵢⱼ is replaced with (Wᵢⱼ_ave−α×Wᵢⱼ_σ), bᵢ is replaced with (bᵢ_ave−α×bᵢ_σ), and const. is replaced with (const._ave−α×const._σ). This produces a combined QUBO.

In this manner, by using the average of the coefficients each for one instance of E(x), a region having a good objective function value may be searched. Furthermore, since a region with a large deviation can also be searched, a region with an element of high uncertainty that has not yet been allowed to be searched may be searched. The greater the degree of search α, the more the deviation is focused, and thus, a region with an element of high uncertainty may be actively searched. If the degree of search α is assigned as zero, a region having a good objective function value may be actively searched.

The determination coefficient R² is an index of the model accuracy, which represents that the closer to one, the better the accuracy of searching for a good solution with a high evaluation value. Note that, although the combined QUBO may be generated regardless of the determination coefficient, a combined QUBO with high accuracy may be generated by excluding an Ising model whose determination coefficient is less than the threshold value 5.

The determination coefficient R² can be calculated by, for example, the following formula.

$${R}^{2} = 1 - \frac{{\sum }_{i = 1}^{n} {( {y}_{i} - \hat{y} )}^{2}}{{\sum }_{i = 1}^{n} {( {y}_{i} - \overline{y} )}^{2}} \qquad [ Mathematical Formula 2 ]$$

In the above, yi denotes an actually measured value. The following formula yields a predicted value.

ŷ [Mathematical Formula 3]

The following formula yields an average value of actually measured values.

y̅ [Mathematical Formula 4]

Next, the FMDA execution unit 40 generates a number of DA recommended points equal to a set number of DA recommendations, by optimizing the combined QUBO generated in step S25 with a DA (step S26). The set number of DA recommendations is preset by the user. The DA recommended point is a good solution (recommended point) giving the best evaluation value. Alternatively, the DA recommended point is a good solution (recommended point) having an evaluation value equal to or greater than a threshold value. Alternatively, the DA recommended points are good solutions (recommended points) having top evaluation values up to a predetermined place.

Next, the FMDA execution unit 40 verifies whether or not the recommended point obtained in step S26 is a point that has already been retrieved in search (step S27). For example, it is verified whether or not the recommended point obtained in step S26 is included in the training data group stored in the storage unit 10.

In a case where it is verified as “Yes” in step S27, the FMDA execution unit 40 updates the maximum value of the degree of search to αₘₐₓ=αₘₐₓ+Δα (step S28).

Next, the FMDA execution unit 40 randomly generates a value between 0 and αₘₐₓ and updates the degree of search α to the generated value (step S29). Thereafter, step S25 and the subsequent steps are executed again.

In a case where it is verified as “No” in step S27, the execution of the flowchart ends.

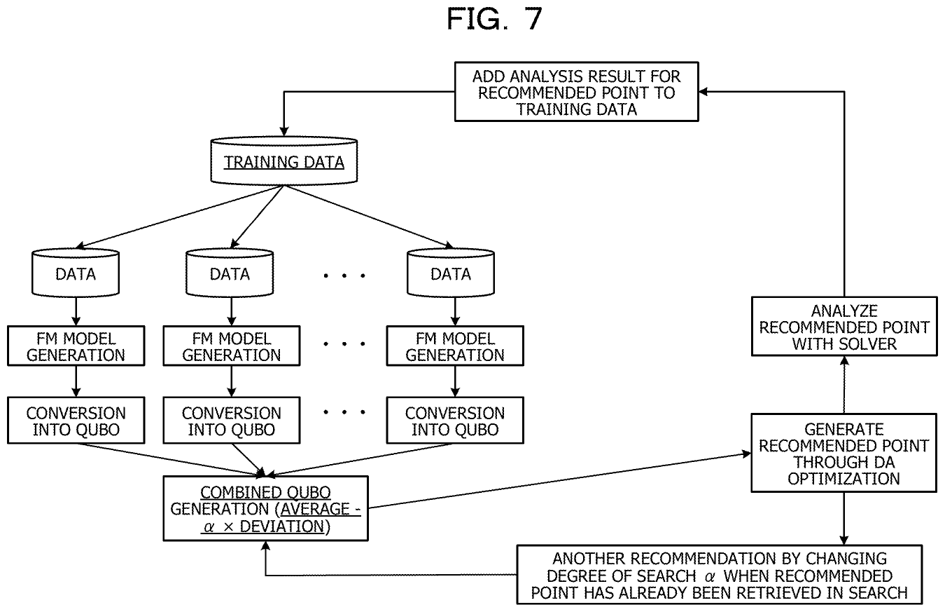

FIG. 7 is a diagram in which the present embodiment is summarized in order. As illustrated in FIG. 7, the initial points of the training data are generated. From this training data group, a plurality of types of training data equal to a designated number are extracted as training data sets. Next, for each training data set, an FM model is generated and converted into QUBO, and an Ising model is generated. According to an average and a deviation of the coefficients in the QUBO format, Ising models having the model accuracy equal to or greater than a threshold value are combined, and a combined QUBO is generated.

A combined QUBO is used to generate a recommended point through DA optimization. In a case where the recommended point has already been retrieved in search, the degree of search α is changed, a new combined QUBO is generated, and a recommended point by DA optimization is generated. When the recommended point has not been retrieved in search, the recommended point is analyzed by the solver, and an analysis result for the recommended point is added to the training data. Thereafter, a similar process is repeated with the updated training data.

According to the present embodiment, since a plurality of Ising models is generated, an average and a deviation of the coefficients (Wᵢⱼ, bᵢ, const.) for each Ising model can be calculated. By considering not only the average but also the deviation of the coefficients when combining a plurality of Ising models, a region with an element of high uncertainty may be searched. Specifically, by combining the Ising models using (average−α×deviation), not only a region having a good objective function value but also a region having a large deviation and having an element of high uncertainty that has not yet been allowed to be searched may be searched. This may suppress falling into a local solution, and as a result, may reduce the number of times of sampling.

When combining a plurality of Ising models, the accuracy of the combined QUBO may be enhanced by excluding an Ising model whose accuracy is less than a threshold value. Since at least two sets of the plurality of training data sets include training data overlapping each other, a plurality of Ising models may be generated even in a case where, for example, the number of pieces of training data such as the initial points is small. By changing the degree of search α and regenerating the combined QUBO in a case where the recommended point retrieved in search by the DA has already been retrieved in search, a search in an unsearched region may be enabled.

Note that, in the above, the degree of search α is updated as in step S29, but may be gradually updated using a step value between 0 and αₘₐₓ. Alternatively, the degree of search α may be updated according to the number of times of repetition of step S13.

### (Simulation Result)

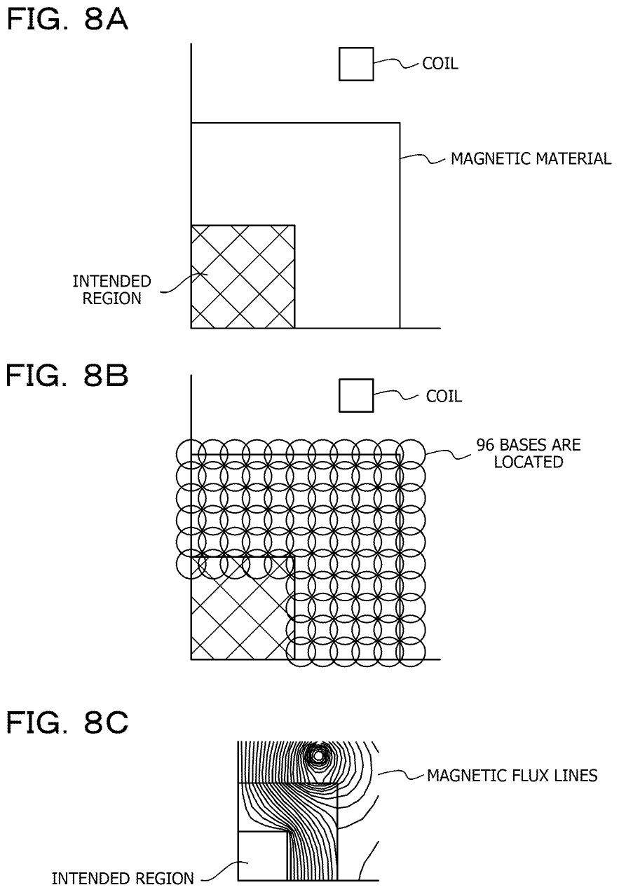

Hereinafter, a simulation result of setting a virtual problem and performing the arithmetic process according to the above embodiment will be described. FIG. 8A is a diagram illustrating an optimization problem for a magnetic shield. FIG. 8A depicts a magnetic shield analysis model and is a diagram illustrating a coil, a design region for a magnetic material, and an intended region. The intended region is a region where the influence of the magnetic flux is desired to be avoided. The design region for the magnetic material is a region for locating the magnetic material. FIG. 8B is a diagram illustrating locations by a Gaussian basis function. As illustrated in FIG. 8B, 96 magnetic materials can be located in the design region for the magnetic material. FIG. 8C is a diagram illustrating magnetic flux lines generated from the coil.

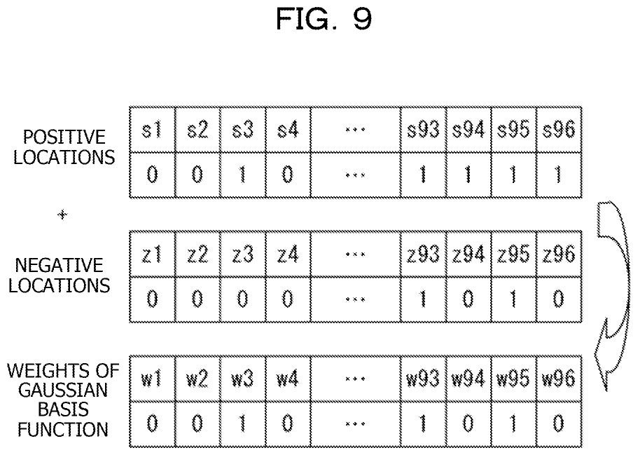

The tables in FIG. 9 are diagrams illustrating positive locations and negative locations. 96 positive located positions are indicated by s1 to s96. In s1 to s96, “0” represents that no magnetic material is located, and “1” represents that a magnetic material is located. 96 negative located positions are indicated by z1 to z96. In z1 to z96, “0” represents that no magnetic material is located, and “1” represents that a magnetic material is located.

This location problem can be represented as a shape function y as in the following formula. In the above formula, sᵢ, zᵢ∈{0, 1} holds and wᵢ∈{−1, 0, 1} holds. In this manner, the optimization problem for the magnetic shield is regarded as a positive-negative location problem of the Gaussian basis function.

$$y ( x , s , z ) = {\sum }_{i = 1}^{{N}_{G}} ( {s}_{i} - {z}_{i} ) \{ {G}_{i} ( x ) / {\sum }_{j = 1}^{{N}_{G}} {G}_{j} ( x ) \} \qquad [ Mathematical Formula 5 ]$$

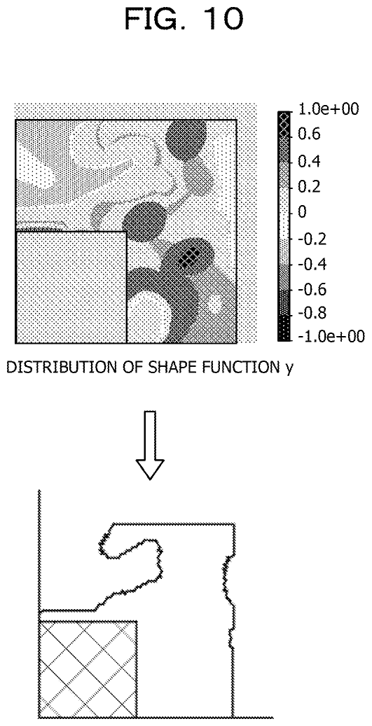

Distribution of the shape function y is as depicted in the upper diagram of FIG. 10. From this result, as depicted in the lower diagram of FIG. 10, material information can be determined from the magnitude of the shape function y. Note that, in the lower diagram of FIG. 10, when the shape function y has zero or greater, a substance is present, and when the shape function y is less than zero, no substance is present.

The purpose of the magnetic shield shape optimization is to minimize magnitude of the average magnetic flux density Bₐᵥₑ^{T} and a magnetic material area S_{mag} in the intended region. The minimization is specifically the minimization in the following formula. Note that E₁ has 1/10 of Bₐᵥₑ^{T} when the entire design region is filled with air. E₂ denotes S_{mag} when the entire design region is filled with the magnetic material.

$$E = \frac{{β}_{1}}{{E}_{1}} {B}_{ave}^{T} + \frac{{β}_{2}}{{E}_{2}} {S}_{mag} \to min . \qquad [ Mathematical Formula 6 ]$$

Sampling was performed on this optimization problem by two types of approaches of an approach only with an FMDA and the approach of the present embodiment. As a common setting, the number of initial points was assumed as 96. The number of iterations was assumed as 192 times, and the threshold value δ was assumed as 0.85. The number N_{d} of pieces of picked-up data was assumed as 400, and the number N_{S} of generated QUBOs was assumed as 10. Weights β₁ and β₂ of the objective function were both assumed as 0.5. In addition, the degree of search α was assumed as 0.5, and an amount of change Δα of the degree of search α was assumed as 0.1.

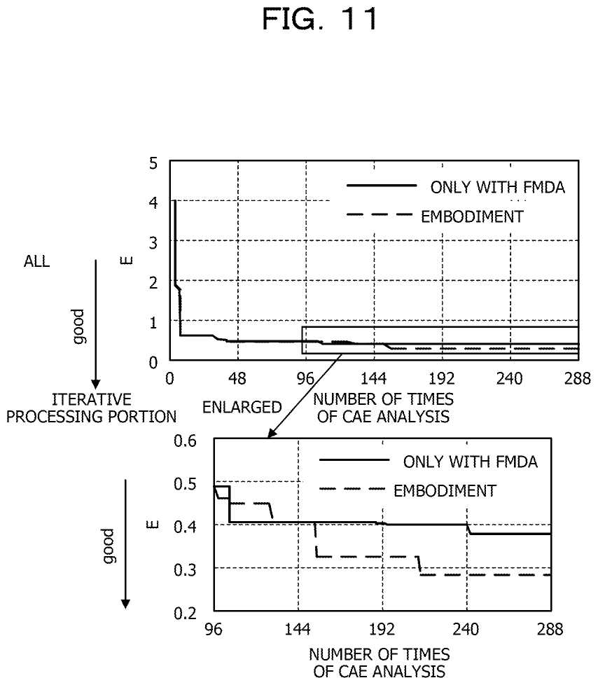

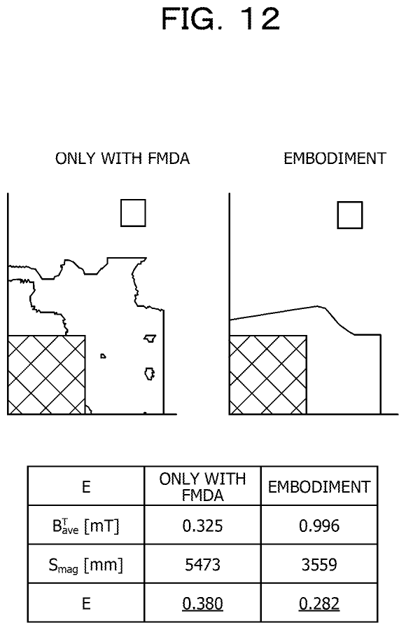

FIGS. 11 and 12 are diagrams indicating results. FIG. 11 indicates the best value found in the search. The vertical axis represents the energy E in the QUBO format. Therefore, in the vertical axis, a smaller value indicates that a better result is obtained. The number of computer aided engineering (CAE) analyses on the horizontal axis indicates the number of iterations. The diagram in the lower part of FIG. 11 is an enlarged diagram obtained by altering the scale of the vertical axis of the diagram in the upper part of FIG. 11. As indicated in FIGS. 11 and 12, it can be seen that the approach of the present embodiment was able to achieve sampling more efficiently than the approach with the FMDA.

In the above example, the FMDA execution unit 40 and the training data update unit 50 are an example of an execution unit that repeatedly executes a process including: generating a plurality of training data sets from a training data group; creating a plurality of Ising models by creating the Ising models for each of the plurality of training data sets; creating a combined Ising model by combining the plurality of Ising models according to an average and a deviation of coefficients of the plurality of Ising models; searching for a recommended point for the combined Ising model; and adding the recommended point and an evaluation value of the recommended point to the training data group.

While the embodiments have been described above in detail, the embodiments are not limited to such specified embodiments, and various modifications and alterations can be made within the scope of the gist of the embodiments described in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an arithmetic program for causing a computer to repeatedly execute processing comprising:
generating a plurality of training data sets from a training data group;
creating a plurality of Ising models by creating the Ising models for each of the plurality of training data sets;
creating a combined Ising model by combining the plurality of Ising models according to an average and a deviation of coefficients of the plurality of Ising models;
searching for a recommended point for the combined Ising model; and
adding the recommended point and an evaluation value of the recommended point to the training data group.

2. The non-transitory computer-readable recording medium according to claim 1, wherein, when the plurality of Ising models is combined, the Ising models whose accuracy is less than a threshold value are excluded.

3. The non-transitory computer-readable recording medium according to claim 1, wherein at least two sets of the plurality of training data sets include training data that overlaps each other.

4. The non-transitory computer-readable recording medium according to claim 1, wherein, in a case where the recommended point retrieved in the search is already included in the training data group, the combined Ising model is recreated by changing a degree of reflection of the deviation when the plurality of Ising models used to search for the recommended point is combined, and the recommended point is searched for, for the recreated combined Ising model.

5. The non-transitory computer-readable recording medium according to claim 1, wherein the coefficients are at least one of coupling coefficients, bias coefficients, or constant terms of the Ising models.

6. An arithmetic method implemented by a computer, comprising:
generating a plurality of training data sets from a training data group;
creating a plurality of Ising models by creating the Ising models for each of the plurality of training data sets;
creating a combined Ising model by combining the plurality of Ising models according to an average and a deviation of coefficients of the plurality of Ising models;
searching for a recommended point for the combined Ising model; and
adding the recommended point and an evaluation value of the recommended point to the training data group, wherein
the generating of the plurality of training, the creating of the plurality of Ising models, the creating of the combined Ising model, the searching for the recommended point, and the adding of the recommended point and the evaluation value are repeatedly executed by the computer.

7. An information processing apparatus comprising:
a memory; and
a processor coupled to the memory, the processor being configured to perform repeatedly processing including:
generating a plurality of training data sets from a training data group;
creating a plurality of Ising models by creating the Ising models for each of the plurality of training data sets;
creating a combined Ising model by combining the plurality of Ising models according to an average and a deviation of coefficients of the plurality of Ising models;
searching for a recommended point for the combined Ising model; and
adding the recommended point and an evaluation value of the recommended point to the training data group.
